(19) United States
(12) Patent Application Publication
(10) Pub. No.: US 2024/0084975 A1
(43) Pub. Date: Mar. 14, 2024

(54) METHOD, INTERNET OF THINGS SYSTEM, AND STORAGE MEDIUM FOR ASSESSING SMART GAS EMERGENCY PLAN

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Lei ZHANG, Chengdu (CN); Siwei ZENG, Chengdu (CN)

(73) Assignee: CHENGDU QINCHUAN IOT TECHNOLOGY CO., LTD., Chengdu (CN)

(21) Appl. No.: 18/510,593

(22) Filed: Nov. 15, 2023

(30) Foreign Application Priority Data
Sep. 12, 2023 (CN) 202311175474.5

(51) Int. Cl. F17D 5/00; G08G 1/00

(52) U.S. Cl. CPC F17D 5/005; G08G 1/202

(57) ABSTRACT

A method, an Internet of Things system, and a storage medium for assessing a smart gas emergency plan are provided, the method is executed by a smart gas safety management platform of the Internet of Things system. The method may include: obtaining a gas pipeline network warning information distribution of a gas pipeline network, the warning information distribution including warning information of at least one warning point location; obtaining gas monitoring data of at least one associated point location corresponding to the at least one warning point location; determining at least one emergency processing point based on the warning information distribution and the gas monitoring data of at least one associated point location; and determining a deployment plan for a gas emergency vehicle based on a gas supply blockage range of the at least one emergency processing point.

### CROSS REFERENCE TO RELATED APPLICATION

This application claims priority of Chinese Patent Application No. 202311175474.5 filed on Sep. 12, 2023, the contents of which are entirely incorporated herein by reference

### TECHNICAL FIELD

The present disclosure relates to the field of gas emergency management, and in particular relates to a method, an Internet of Things (IoT) system and a storage medium for assessing a smart gas emergency plan.

### BACKGROUND

In a gas emergency processing, it is necessary to stop a gas or reduce a pressure of a faulty pipeline, etc. The gas stop or pressure reduction processing may have an impact on a normal gas consumption of residential users and a normal production and operation of commercial users. In order not to affect life and work of residents, emergency gas may be used for temporary gas supply to an area where an emergency occurs.

Aiming at a problem of how to carry out an emergency gas supply, CN104732339A discloses a gas emergency repair treatment optimization method based on an emergency plan. After first using a preset emergency plan for emergency treatment, emergency treatment data may be statistically analyzed, and an optimized treatment result corresponding to the current emergency repair may be determined based on a statistical analysis result. However, the method only involves optimizing an emergency plan corresponding to the current emergency response in hindsight, and does not involve pre-determining the corresponding emergency plan for possible emergency response events based on an actual situation.

Therefore, it is desirable to provide a method, an Internet of Things system, and a storage medium for assessing a smart gas emergency plan, which are capable of efficiently and accurately determining a low-risk, low-cost gas emergency plan.

### SUMMARY

One of the embodiments of the present disclosure provides a method for assessing a smart gas emergency plan. The method may be performed by a smart gas safety management platform of an Internet of Things (IoT) system for assessing a smart gas emergency plan. The method for assessing a smart gas emergency plan may include: obtaining a warning information distribution of a gas pipeline network, the warning information distribution including warning information of at least one warning point location, the warning point location being a pipeline currently sending an alarm; obtaining gas monitoring data of at least one associated point location corresponding to the at least one warning point location, the at least one associated point location being adjacent to the warning point location; determining, based on the warning information distribution and the gas monitoring data of the at least one associated point location, at least one emergency processing point; and determining, based on a gas supply blockage range of the at least one emergency processing point, a deployment plan for a gas emergency vehicle.

One of the embodiments of the present disclosure provides the IoT system for assessing a smart gas emergency plan. The IoT system for assessing a smart gas emergency plan may include a smart gas user platform, a smart gas service platform, a smart gas safety management platform, a smart gas sensor network platform, and a smart gas object platform. The smart gas safety management platform may be configured to obtain an warning information distribution of a gas pipeline network, the warning information distribution including warning information of at least one warning point location, the warning point location being a pipeline currently sending an alarm; obtain gas monitoring data of at least one associated point location corresponding to the at least one warning point location, the at least one associated point location being adjacent to the warning point location; determine, based on the warning information distribution and the gas monitoring data of the at least one associated point location, at least one emergency processing point; and determine, based on a gas supply blockage range of the at least one emergency processing point, a deployment plan for a gas emergency vehicle.

One of the embodiments of the present disclosure provides a computer-readable storage medium. The storage medium may store a computer command, and the computer may execute the method for assessing a smart gas emergency plan when the computer reads the computer command in the storage medium.

Some embodiments of the present disclosure may have at least the following beneficial effect: based on the warning information distribution and the gas monitoring data of the associated point location, a plurality of emergency processing points may be determined, and the gas emergency vehicle deployment plan may be scientifically formulated based on the gas supply blockage range for each emergency processing point, thereby ensuring that the gas emergency vehicle may quickly reach the corresponding emergency processing point and provide effective gas supply and maintenance services in emergency situations.

### BRIEF DESCRIPTION OF THE DRAWINGS

The present disclosure will be further illustrated by way of exemplary embodiments, which will be described in detail with reference to the accompanying drawings. These embodiments are not limiting, and in these embodiments, the same numbering denotes the same structure, wherein:

FIG. 1 is a schematic diagram illustrating an exemplary Internet of Things (IoT) system for assessing a smart gas emergency plan according to some embodiments of the present disclosure;

FIG. 2 is an exemplary flowchart of a method for assessing a smart gas emergency plan according to some embodiments of the present disclosure;

FIG. 3 is an exemplary schematic diagram of determining a point to be reinforced according to some embodiments of the present disclosure; and

FIG. 4 is an exemplary schematic diagram of determining a deployment plan according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following descriptions are only some examples or embodiments of the present disclosure, and for those skilled in the art may apply the present disclosure to other similar scenarios based on these drawings without creative labor. Unless obviously obtained from the context or explicitly stated otherwise, the same numeral in the drawings refers to the same structure or operation.

It should be understood that the terms “system”, “device”, “unit” and/or “module”, as used herein, are used to distinguish between different components, elements, parts, sections, or assemblies at different levels. However, the words may be replaced by other expressions if other words accomplish the same purpose.

As shown in the present disclosure and the claims, unless the context clearly suggests an exception, the words “one”, “a”, “an”, and/or “the” do not refer specifically to the singular form, but may also include the plural form. Generally, the terms “including” and “comprising” suggest only the inclusion of clearly identified operations and elements that do not constitute an exclusive list, and the method or apparatus may also include other operations or elements.

Flowcharts are used in the present disclosure to illustrate operations performed by a system according to embodiments of the present disclosure. It should be appreciated that the preceding or following operations are not necessarily performed in an exact sequence. Instead, operations may be processed in reverse order or simultaneously. Also, it is possible to add other operations to these processes or remove an operation or some operations from these processes.

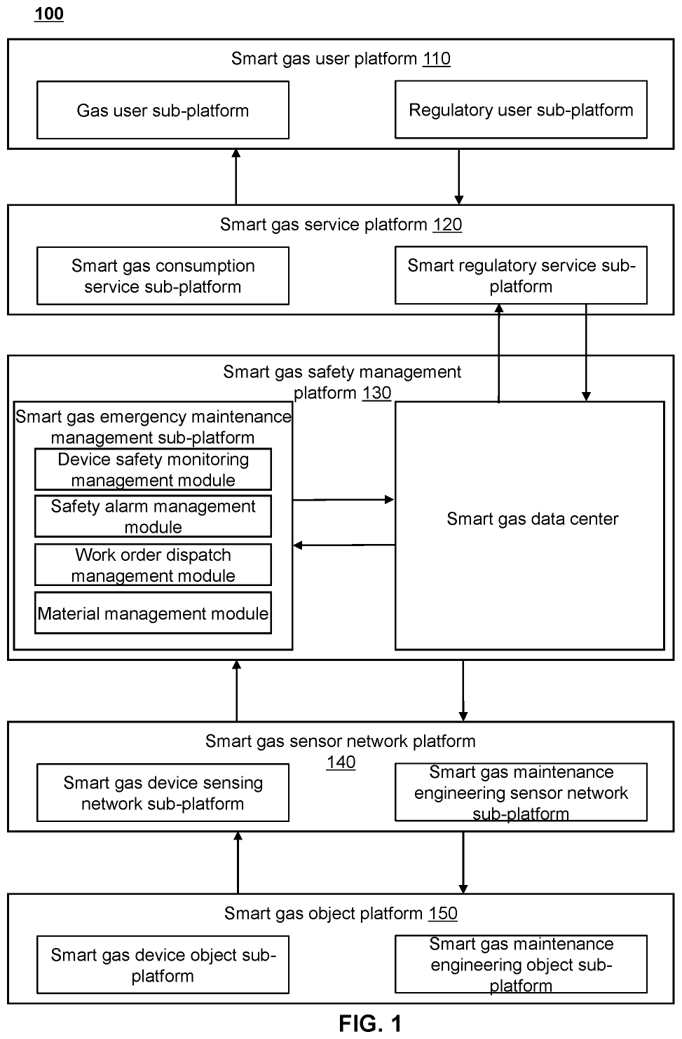

FIG. 1 is a schematic diagram illustrating an exemplary Internet of Things (IoT) system for assessing a smart gas emergency plan according to some embodiments of the present disclosure. It should be noted that the following embodiments are provided only to explain the present disclosure and do not constitute a limitation of the present disclosure.

As shown in FIG. 1, the IoT system for assessing a smart gas emergency plan 100 may include a smart gas user platform 110, a smart gas service platform 120, a smart gas safety management platform 130, a smart gas sensor network platform 140, and a smart gas object platform 150.

The smart gas user platform 110 may be a platform for interacting with a user. In some embodiments, the smart gas user platform 110 may be configured as a terminal device.

In some embodiments, the smart gas user platform 110 may include a gas user sub-platform and a regulatory user sub-platform.

The gas user sub-platform may be a platform that provides gas users with data related to a gas usage and a solution to a gas problem. A gas user may be an industrial gas user, a commercial gas user, or an ordinary gas user, etc.

The regulatory user sub-platform may be a platform for regulating an operation of the entire IoT system. A regulatory user may be a person from a safety management department.

In some embodiments, the smart gas user platform 110 may send a gas emergency plan query command to the smart gas service platform 120, and receive a gas emergency plan uploaded by the smart gas service platform 120.

The smart gas service platform 120 may be a platform for communicating demand and control information from the user. The smart gas service platform 120 may obtain the gas emergency plan, etc. from the smart gas safety management platform 130 (e.g., a smart gas data center), and send the gas emergency plan to the smart gas user platform 110.

In some embodiments, the smart gas service platform 120 may include a smart gas consumption service sub-platform and a smart regulatory service sub-platform.

The smart gas consumption service sub-platform may be a platform that provides a gas service to the gas user.

The smart regulatory service sub-platform may be a platform that provide a regulatory demand for the regulatory user.

In some embodiments, the smart gas service platform 120 may issue a gas emergency plan query command issued by the smart gas user platform 110 to the smart gas data center; and receive a gas emergency plan uploaded by the smart gas data center.

The smart gas safety management platform 130 may be a platform for overall planning and coordinating connections and cooperations among various functional platforms, gathering all information of the IoT system, and providing functions of perceptual management and control management for the IoT operation system.

In some embodiments, the smart gas safety management platform 130 may include a smart gas emergency maintenance management sub-platform and the smart gas data center in a two-way interaction.

In some embodiments, the smart gas emergency maintenance management sub-platform may include a device safety monitoring management module, a safety alarm management module, a work order dispatch management module, and a material management module.

The smart gas data center may be configured to store and manage all operational information of the IoT system 100 for assessing a smart gas emergency plan. In some embodiments, the smart gas data center may be configured as a storage device for storing data related to assessing gas emergency plans, etc.

In some embodiments, the smart gas safety management platform 130 may interact with the smart gas service platform 120 and the smart gas sensor network platform 140 through the smart gas data center, respectively, for information exchange. For example, the smart gas data center may upload the gas emergency plan to the smart gas service platform 120. For example, the smart gas data center may send command to the smart gas sensor network platform 140 to obtain and receive data related to assessing the gas emergency plan.

The smart gas sensor network platform 140 may be a functional platform for managing sensor communication. In some embodiments, the smart gas sensor network platform 140 may be a functional platform for sensor information communication and control information communication. In some embodiments, the smart gas sensor network platform 140 may be configured as a communication network and gateway.

In some embodiments, the smart gas sensor network platform 140 may include a smart gas device sensing network sub-platform and a smart gas maintenance engineering sensor network sub-platform.

The smart gas device sensing network sub-platform may correspond to a smart gas device object sub-platform and may be used to issue commands to obtain safety-related data (such as operational information) of the gas device to the smart gas device object sub-platform, and upload the safety-related data of the gas device to the smart gas data center.

The smart gas maintenance engineering sensor network sub-platform may correspond to a smart gas maintenance engineering object sub-platform and may be used to issue a command to obtain maintenance engineering related information (such as a progress, a staffing, and a material allocation) to the smart gas maintenance engineering object sub-platform. The smart gas maintenance engineering sensor network sub-platform may be further configured to upload the maintenance project related information to the smart gas data center.

The smart gas object platform 150 may be a functional platform for generating perceptual information and executing controlling information.

In some embodiments, the smart gas object platform 150 may include the smart gas device object sub-platform and the smart gas maintenance engineering object sub-platform.

In some embodiments, the smart gas device object sub-platform may be configured as various types of gas and monitoring devices. The monitoring devices may include gas flow meters, temperature sensors, pressure sensors, float meters, etc.

In some embodiments, the smart gas maintenance engineering object sub-platform may be configured as various types of maintenance devices. The maintenance devices may include maintenance vehicles (e.g., gas emergency vehicles), maintenance appliances, and alarm devices, etc.

In some embodiments of the present disclosure, based on the IoT system for assessing a smart gas emergency plan 100, a closed loop of information operation between the smart gas object platform 150 and the smart gas user platform 110 may be formed, coordinated, and operated regularly under a unified management of the smart gas safety management platform 130, thereby realizing informationization, and smartness of a gas emergency plan assessment.

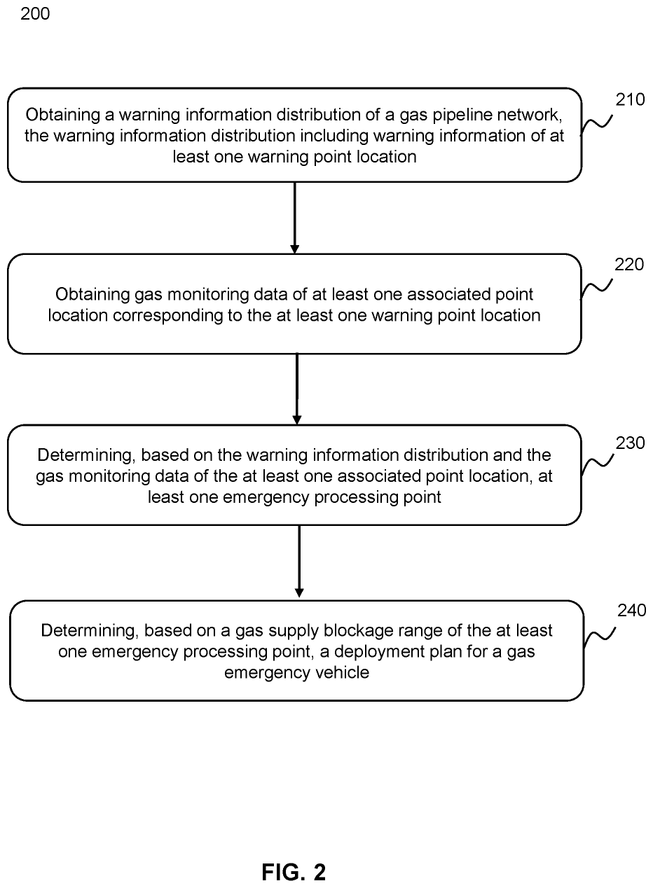

FIG. 2 is an exemplary flowchart of a method for assessing a smart gas emergency plan according to some embodiments of the present disclosure. In some embodiments, a process 200 may be executed by a smart gas safety management platform. As shown in FIG. 2, the process 200 may include the following operations.

In 210, obtaining a warning information distribution for a gas pipeline network, the warning information distribution including warning information of at least one warning point location.

The warning information distribution refers to a distribution of warning information in a gas pipeline network. The warning information distribution may include the warning information of the at least one warning point location.

When an alarm device configured in a smart gas object platform detects a possible abnormal situation in a pipeline, the warning device may upload the warning information to the smart gas safety management platform through a smart gas sensor network platform. The possible abnormal situation includes, but not limited to, a gas pressure not being within a normal pressure range, a gas temperature not being within a normal temperature range, etc.

The warning point location refers to the pipeline where an alarm is currently issued.

In some embodiments, when the smart gas safety management platform receives the warning information uploaded by the smart gas object platform, the smart gas safety management platform may determine the pipeline corresponding to the warning information as the warning point location, and determine the warning information distribution based on the plurality of warning point locations.

In 220, obtaining gas monitoring data of at least one associated point location corresponding to the at least one warning point location.

The associated point location refers to a pipeline associated with the warning point location. In some embodiments, the associated point location may be adjacent to the warning point location. The adjacency may include the pipeline corresponding to the associated point location being connected up and down to the pipeline corresponding to the warning point location, the pipeline corresponding to the associated point location having the same gas main pipelines with the pipeline corresponding to the warning point location, etc.

There may be one or more associated point locations corresponding to the warning point location.

In some embodiments, the smart gas safety management platform may be configured to determine the pipeline adjacent to the warning point location as the associated point location.

In some embodiments, the associated point location may be adjacent to the warning point location and may have the plurality of synchronous anomalies with the warning point location. The plurality of occurrences refer to a number of times greater than a number of times threshold. The number of times threshold may be a system preset value or a human preset value. The synchronous anomalies refer to situations where simultaneous anomalies occur in historical anomaly data. The historical anomaly data may include data related to past anomalies in each pipeline in the gas pipeline network. The occurrence of anomalies may include, but not limited to, a pipeline exposure, a pipeline cracking, a pipeline deformation, a gas leakage, etc.

In some embodiments, the smart gas safety management platform may determine, based on a point feature of the warning point location and historical anomaly data, a synchronized anomaly point location; and determine at least one associated point location based on the synchronized anomaly point location.

The point feature of the warning point location refers to a relevant feature of the warning point location. The point feature of the warning point location may include a gas pressure, a gas temperature, a gas flow rate, etc., at the warning point location. In some embodiments, the smart gas safety management platform may obtain the point feature of the warning point location from the smart gas object platform based on the smart gas sensor network platform.

In some embodiments, the smart gas safety management platform may obtain the historical anomaly data from the smart gas object platform based on the smart gas sensor network platform.

The synchronized anomaly point location refers to a point location that have synchronized anomalies with the warning point location for the plurality of times. The smart gas safety management platform may obtain the synchronized anomaly point location in the plurality of ways. In some embodiments, the smart gas safety management platform may, based on the point feature of the warning point location and the historical anomaly data, analyze, and obtain a pipeline with a synchronous abnormally occurring with the warning point location and the number of times of the synchronous abnormalies exceeding a number threshold, and determine the pipeline as the synchronized anomaly point location.

In some embodiments, the smart gas safety management platform may determine an anomaly point location set based on the point feature of the warning point location and the historical anomaly data; and determine the synchronized anomaly point location based on the anomaly point location set.

In some embodiments, the anomaly point location set may include a plurality of anomalies with an anomaly degree greater than an anomaly degree threshold.

The anomaly degree refers to a number of times an anomaly has occurred in synchronization with the warning point location. In some embodiments, the smart gas safety management platform may perform a statistical analysis on the historical anomaly data to determine the anomaly degree between each individual point in the gas pipeline network (or individual pipeline) and the warning point location.

The anomaly point location refers to the pipeline where an abnormal situation occurs. Referring to the above description for information regarding the anomalies.

In some embodiments, the smart gas safety management platform may analyze and obtain a plurality of pipelines with anomaly degrees greater than the anomaly degree threshold based on the historical anomaly data, and determine the plurality of pipelines as the anomaly point location set.

In some embodiments, the smart gas safety management platform may analyze and obtain the plurality of pipelines with the anomaly degrees greater than the threshold based on the historical anomaly data as candidate point locations. The smart gas safety management platform may determine a similarity between point feature of each candidate point location and the point feature of the warning point location. A plurality of candidate point locations with feature similarities greater than a similarity threshold may be determined as the anomaly point locations. Modes for calculating the feature similarity may include, but not limited to a cosine similarity, a Euclidean distance, a Manhattan distance, etc.

In some embodiments, the anomaly degree threshold may be set manually.

In some embodiments, different anomaly point location sets may correspond to different anomaly degree thresholds. In some embodiments, the anomaly degree threshold is at least correlated with a total number of anomalies in the anomaly point location set and a distance distribution of each anomaly point location in the anomaly point location set. For example, the anomaly degree threshold may be positively correlated with the total number of anomalies in the anomaly point location set. Alternatively, the anomaly degree threshold may be negatively correlated with an average distance of each anomaly point location in the anomaly point location set.

The total number of anomalies in the anomaly point location set refers to a sum of the number of anomalies at each anomaly point location in the anomaly point location set since the gas pipeline network is put into operation. In some embodiments, the smart gas safety management platform may obtain the total number of anomalies of the anomaly point location set from the smart gas object platform based on the smart gas sensor network platform.

The distance distribution may include the distance between each two anomaly point locations in the anomaly point location set. For example, if an anomaly point location set A is (anomaly point location 1, anomaly point location 2, anomaly point location 3), then the distance distribution for each anomaly in the anomaly point location set A may be (distance between anomaly point location 1 and anomaly point location 2, distance between anomaly point location 1 and anomaly point location 3, distance between anomaly point location 2 and anomaly point location 3).

In some embodiments, the smart gas safety management platform may obtain the distance distribution from the smart gas object platform based on the smart gas sensor network platform.

In some embodiments of the present disclosure, by taking the total number of anomalies and the distance distribution of each abnormally point position in the anomaly point location set as factors for the anomaly degree threshold, a more accurate and adaptable setting of the anomaly degree threshold may be achieved, and the anomaly degree of the anomaly point location set may be better reflected, thereby more effectively determining the synchronized anomaly point location that occur simultaneously with the warning point location.

In some embodiments, the anomaly degree threshold may also be correlated to a service life of the gas pipeline network. For example, the anomaly degree threshold may be positively correlated to the service life of the gas pipeline network.

The service life of the gas pipeline network refers to a number of years since the gas pipeline network is put into operation. In some embodiments, the smart gas safety management platform may obtain the service life of the gas pipeline network based on the smart gas sensor network platform from the smart gas maintenance engineering object sub-platform in the smart gas object platform.

The longer the service life of the gas pipeline network, the older the gas pipeline network, and the more prone it may be to problems in many areas. At this time, the simultaneous occurrence of problems may not be due to a high degree of correlation but rather to aging. In some embodiments of the present disclosure, by dynamically adjusting the anomaly degree threshold based on the service life of the gas pipeline network, false alarms caused by aging of the pipeline and other reasons may be reduced.

In some embodiments, the anomaly degree threshold may also be correlated to the average service life of the pipelines corresponding to the anomaly point location set. For example, the anomaly degree threshold may be positively correlated to the average service life of the pipelines corresponding to the anomaly point location set. The average service life of the pipelines refers to an average age of a plurality of pipelines since the gas pipeline network is put into operation. The above plurality of pipelines corresponds to the anomaly point location set. The average service life of the pipelines may be obtained in a manner similar to that of the service life of the gas pipeline network, which is not repeated here.

In some embodiments, the smart gas safety management platform may determine all of the anomaly point locations in the anomaly point location set as the synchronized anomaly point locations. The synchronized anomaly point locations may also be determined in other ways, which are not limited here.

In some embodiments of the present disclosure, the anomaly point location set may be determined based on the point feature of the warning point locations and the historical anomaly data, and the synchronized anomaly point location may be determined based on the anomaly point location set. In this way, a potential synchronized anomaly point location may be discovered in a timely manner, thereby improving an accuracy of detecting the associated point location.

In some embodiments, the smart gas safety management platform may determine the synchronized anomaly point location adjacent to the warning point location as the associated point location. The associated point location may also be determined in other ways, which are not limited herein.

In some embodiments of the present disclosure, determining the associated point location based on the synchronized anomaly point location allows for a more comprehensive consideration of the factors related to the warning point location, thereby further expanding a range of the associated point location, and improving the accuracy of detecting an emergency processing points.

The gas monitoring data refers to monitoring data obtained at the associated point location. For example, the gas monitoring data may include a gas flow rate, the gas pressure, etc.

In some embodiments, the smart gas safety management platform may obtain the gas monitoring data from the smart gas object platform based on the smart gas sensor network platform.

In 230, determining, based on the warning information distribution and the gas monitoring data of the at least one associated point location, at least one emergency processing point.

The emergency processing point refers to the pipeline that requires an emergency treatment.

In some embodiments, the smart gas safety management platform may determine the warning point location corresponding to the associated point location of the at least one type of the gas monitoring data that is beyond a normal data range as the emergency processing point. The normal data range may be a preset value by the system or a manually preset value. Different types of the gas monitoring data may correspond to different normal data ranges. For example, the gas temperature may correspond to a normal temperature range, and gas pressure may correspond to a normal pressure range.

In some embodiments, at least one emergency processing point may include a point to be supplied with gas and a point to be repaired.

The point to be supplied with gas refers to a pipeline that needs a temporary gas supply.

The point to be repaired refers to a pipeline that needs repair. For example, the point to be repaired may be a pipeline with abnormal situations such as a pipeline cracking, a pipeline deformation, a gas leakage, etc.

In some embodiments, the smart gas safety management platform may determine the point to be repaired based on the gas monitoring data. For example, the smart gas safety management platform may determine the gas monitoring data corresponding to a historical point to be repaired as reference to be repaired monitoring data, and determine the pipeline whose vector distance between the gas monitoring data and the reference to be repaired monitoring data less than a distance threshold as the point to be repaired.

In some embodiments, the smart gas safety management platform may determine a point to be supplied with gas based on the gas pipeline network and the point to be repaired. For example, a pipeline located at a downstream of the point to be repaired may be determined as the point to be supplied with gas based on an upstream and downstream relationship of each pipeline in the gas pipeline network.

In some embodiments of the present disclosure, setting the point to be supplied with gas and the point to be repaired as the emergency processing points may help a gas emergency vehicle to determine the problem more quickly and take corresponding measures in time to improve a speed of an emergency response, and facilitate a reasonable allocation of resources.

In some embodiments, the emergency processing point may further include a point to be reinforced.

The point to be reinforced refers to a pipeline needs to be reinforced. For example, the point to be reinforced may be a pipeline that is likely to rupture.

The smart gas safety management platform may determine the point to be reinforced in various ways. In some embodiments, the smart gas safety management platform may determine the point to be reinforced based on the gas monitoring data. For example, the smart gas safety management platform may analyze the gas monitoring data corresponding to the pipeline at various time points, determine a trend of change of the gas detection data, and determine the pipeline with the trend of change greater than a trend threshold as the point to be reinforced. The trend threshold may be a value preset by the system or by the human.

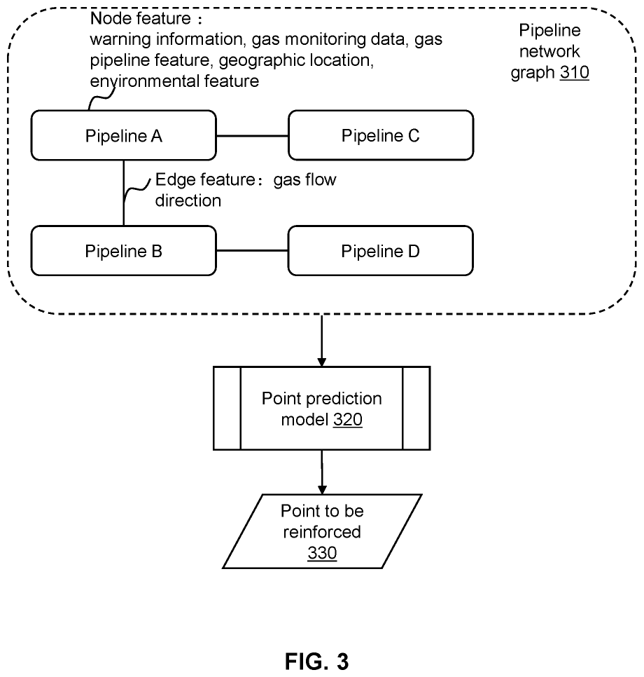

In some embodiments, the smart gas safety management platform may determine the point to be reinforced by a point prediction model. For more information about the point prediction model, please refer to FIG. 3 and the related contents.

In 240, determining, based on a gas supply blockage range of the at least one emergency processing point, a deployment plan for the gas emergency vehicle.

The gas supply blockage range refers to a range of fault influence at the emergency processing point.

In some embodiments, the gas supply blockage range may be determined based on the upstream and downstream pipelines of the emergency processing point. For example, a failure in Pipeline A may affect all pipelines upstream and downstream of the pipeline where Pipeline A is located, then all pipelines upstream and downstream of Pipeline A may be determined as the gas supply blockage range. For another example, if a gas flow direction is from Pipeline A to Pipeline B to Consumer 1, and from Pipeline A to Pipeline C to Consumer 2, then if Pipeline A fails, the gas supply blockage range may include Pipeline B, Pipeline C, Consumer 1, and Consumer 2.

The gas emergency vehicle refers to a vehicle used for gas repairs.

In some embodiments, the gas emergency vehicle may be configured for pipeline crossover, gas supply, and gas pressure regulation. The pipeline crossover may connect two pipelines together to maintain a continuity of the gas supply. For example, in an original pipeline layout, the gas may flow from Pipeline A to Pipeline B and then to Pipeline C. When Pipeline B fails, Pipeline A and Pipeline C may be directly connected by the gas emergency vehicle, so that the gas bypasses the faulty Pipeline B. If the gas emergency vehicle is directly supplying gas, the gas emergency vehicle may be directly connected to Pipeline C without the need to dismantle Pipeline B.

The deployment plan refers to an arrangement of gas repairs utilizing the gas emergency vehicle.

In some embodiments, the deployment plan may include the deployment point location for the gas emergency vehicle and deployment parameters of the gas emergency vehicle.

The deployment point location may be a location of the gas emergency vehicle. The deployment point location may include one or more locations.

The deployment parameters refer to parameters related to the gas maintenance performed by the gas emergency vehicle. The deployment parameters may include at least one of a crossover parameter, a gas supply parameter, and a pressure regulation parameter.

The crossover parameter refers to a parameter related to pipeline crossover performed by the gas emergency vehicle. For example, the crossover parameter may include the location of the pipeline to be cross overed, a connection method of the crossover pipeline, a pipeline diameter of the crossover pipeline, etc.

The gas supply parameter refers to relevant parameters for gas supply performed by the gas emergency vehicle. For example, the gas supply parameter may include the gas supply flow rate, the gas supply pressure, etc.

The pressure regulation parameter refers to the relevant parameters for gas pressure regulation performed by the gas emergency vehicle. For example, the pressure regulation parameter may include a regulation range, a regulation amplitude, etc.

In some embodiments of the present disclosure, the deployment plan may include a deployment point location and a deployment parameter of the gas emergency vehicle, and may ensure that the gas emergency vehicle may quickly reach the emergency processing point in case of emergencies, and provide timely and appropriate gas repair services, thereby improving a reliability and safety of the gas supply.

The smart gas safety management platform may determine the deployment plan through various modes. In some embodiments, the smart gas safety management platform may randomly select one or more locations within the gas supply blockage range of a certain emergency processing point as the deployment point location for the gas emergency vehicle. In some embodiments, the smart gas safety management platform may select the location where the emergency processing point is located as the deployment point location for the gas emergency vehicle.

In some embodiments, the smart gas safety management platform may determine correspondences between sizes of different gas supply blockage ranges and different deployment parameters based on the historical data, and store the correspondences in a table in advance. After obtaining the gas supply blockage range, the deployment parameters may be determined by checking the table, etc.

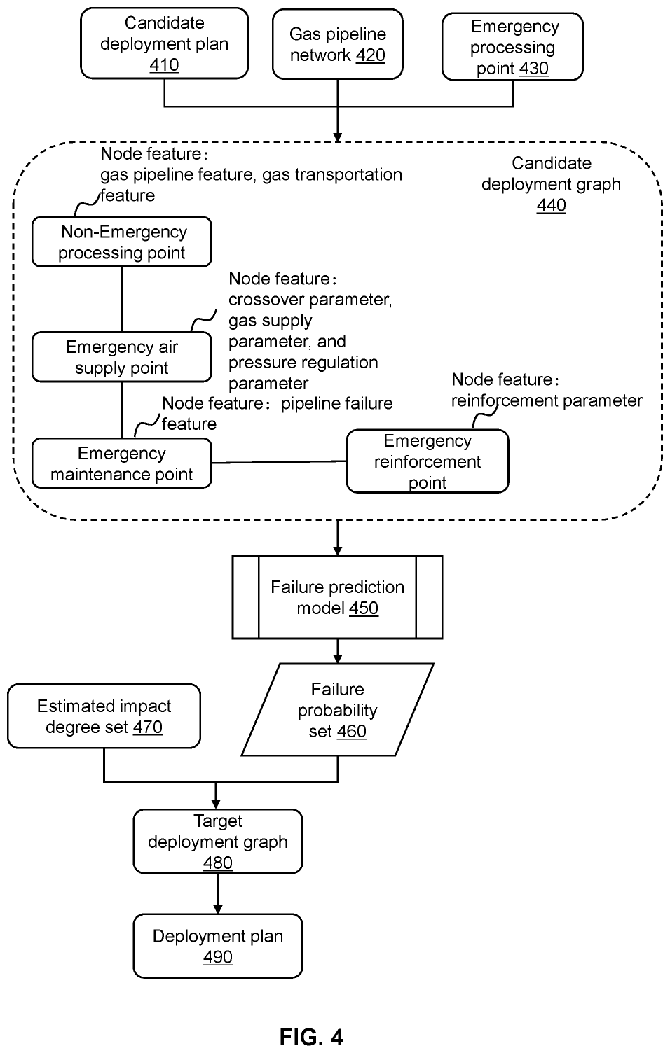

In some embodiments, the smart gas safety management platform may determine the deployment plan based on a failure prediction model. For a more descriptions of the failure prediction model, please refer to FIG. 4 and the related contents.

In some embodiments of the present disclosure, based on the warning information distribution and the gas monitoring data at the associated point location, a plurality of the emergency processing points may be determined, and the deployment plan for the gas emergency vehicles may be scientifically formulated based on the gas supply blockage range at each emergency processing point. The deployment plan may ensure that the gas emergency vehicles may quickly reach corresponding emergency processing points and provide effective gas supply and repair services in emergencies.

It should be noted that the above description of the process is merely exemplary and illustrative, and does not limit the scope of the present disclosure. For those skilled in the art, various modifications and changes may be made to the process under the guidance of the present disclosure. However, these modifications and changes remain within the scope of the present disclosure.

FIG. 3 is an exemplary schematic diagram of determining a point to be reinforced according to some embodiments of the present disclosure.

In some embodiments, an emergency processing point may also include a point to be reinforced. In some embodiments, a smart gas safety management platform may determine the point to be reinforced based on a warning information distribution and gas monitoring data of at least one associated point location through a point prediction model.

In some embodiments, the point prediction model may be a machine learning model. In some embodiments, a type of the point prediction model may include a neural network models (NN) and a convolutional neural network (CNN) model.

In some embodiments, an input to the point prediction model may include the warning information distribution and the gas monitoring data for at least one associated point location, and an output may be the point to be reinforced. For a more detailed explanation of the warning information distribution and the gas monitoring data, please refer to FIG. 2 and the related contents.

In some embodiments, the point prediction model may be obtained based on a great number of first training samples with first labels. In some embodiments, the first training sample may be a sample warning information distribution of a sample gas pipeline network and sample gas monitoring data of at least one sample associated point location, with the first label being an actual reinforced point in the sample gas pipeline network. The first training sample and the first label may be obtained based on historical data.

An exemplary training process may include: inputting a plurality of first training samples with the first labels into an initial point prediction model, constructing a loss function based on the first labels and a result of the initial point prediction model, and iteratively updating a parameter of the initial point prediction model based on the loss function. The model training may be completed when the loss function of the initial point prediction model satisfies a predetermined condition, and then a trained point prediction model may be obtained. The preset condition may be that the loss function converges, a number of iterations reaches a threshold, etc.

In some embodiments of the present disclosure, the point prediction model may be used to process the warning information distribution and the gas monitoring data. A self-learning ability of the machine learning model may be utilized to find patterns from a great amount of input data (e.g., the warning information distribution and the gas monitoring data), and a correlation between the point to be reinforced and the input data may be obtained, thereby improving accuracy and efficiency of determining the point to be reinforced.

In some embodiments, the point prediction model may be a Graph Neural Network (GNN) model. In some embodiments, as shown in FIG. 3, an input of a point prediction model 320 may be a pipeline network graph 310 constructed based on the structure of the gas pipeline network, and an output may be a point to be reinforced 330. The point to be reinforced 330 may be output by nodes in the GNN.

In some embodiments, the smart gas safety management platform may construct a pipeline network map 310 based on a location of each pipeline and an adjacency between the pipelines in a structure of the gas pipeline network.

The pipeline network graph 310 may be a data structure consisting of nodes and edges, where edges connect nodes, and both nodes and edges have attributes.

In some embodiments, the nodes of the pipeline network graph 310 may correspond to each pipeline, and the edges may correspond to adjacent relationships between the pipelines. As shown in FIG. 3, the pipeline network graph 310 may include nodes corresponding to pipeline A, pipeline B, pipeline C, and pipeline D. There may be an edge between the adjacent pipelines A and B, another edge between the adjacent pipelines A and C, and a third edge between the adjacent pipelines B and D.

A node feature may reflect a relevant feature of the corresponding pipeline. In some embodiments, the node feature may include the warning information, the gas monitoring data, and other information.

For more information on the warning information distribution and the gas monitoring data, please refer to FIG. 2 and the related contents.

In some embodiments, the node feature may also include a gas pipeline feature, a geographic location, and an environmental feature.

The gas pipeline feature refers to the feature associated with the pipeline corresponding to the node. For example, the gas pipeline feature may include a pipeline material, a pipeline usage duration, a pipeline structure, a pipeline disclosure, etc.

The geographic location refers to the position of the pipeline corresponding to the node. For example, the geographic location may include latitude and longitude coordinates of the pipeline.

The environmental feature refers to the environmental situation in which the pipeline corresponding to the node is located. For example, the environmental feature may include an environmental temperature, an environmental humidity, etc.

In some embodiments of the present disclosure, a situation of the pipeline itself, as well as the geographic location and the environmental situation in which the pipeline is located may be considered when determining reinforcement point information of each pipeline. This approach allows the determined reinforcement point information of each pipeline to be more realistic and improves an accuracy of the reinforcement point information.

In some embodiments, situations in which there is a neighboring relationship between pipelines may include when two or more pipelines are located in the same area (the area may be pre-determined), and when two or more pipelines share the same gas main pipeline, etc.

The edge feature may reflect a correlated feature between the two corresponding pipelines. In some embodiments, the edge feature may at least include a gas flow direction.

The gas flow direction refers to a direction of an internal gas flow in each pipeline in a target area.

The features of the nodes and edges may be determined using various modes based on basic data. A data source may be the modes described in other embodiments or may be other modes. The data may include real-time data or historical gas pipeline network data.

In some embodiments, the point location prediction model may also be another graph model, such as a graph convolutional neural network model (GCNN), or a graph neural network model with additional processing layers and modified processing modes.

In some embodiments, the point location prediction model may be trained using a second training sample with a second label. For example, the second training sample may be a historical pipeline network map determined based on the historical data. Nodes and features of the nodes, as well as edges and features of the edges, of the historical pipeline network map may be similar to the descriptions above, and the second labels may be the historical reinforcement points corresponding to the historical pipeline network map.

In some embodiments of the present disclosure, the pipeline network map may be constructed based on the structure of the gas pipeline network, and the point to be reinforced may be determined based on the pipeline network map, thereby fully considering the gas flow in each pipeline, improving the accuracy of the information about the points to be reinforced and making it more consistent with the actual situation.

FIG. 4 is an exemplary schematic diagram of determining a deployment plan according to some embodiments of the present disclosure.

In some embodiments, a smart gas safety management platform may determine a plurality of candidate deployment plans 410; construct a plurality of candidate deployment plans based on the gas pipeline network 420, the at least one emergency processing point 430, and the plurality of candidate deployment plans 410. For each candidate deployment graph 440, the smart gas safety management platform may determine, based on a failure prediction model 450, a failure probability of each node in the candidate deployment graph 440 at least one future moment; determine, based on a failure probability set 460 and an estimated impact degree set 470 for each of the plurality of the candidate deployment graphs 440, a target deployment graph 480; and, determine, based on the target deployment graph 480, a deployment plan 490 of a gas emergency vehicle.

The candidate deployment plan 410 refers to an initially determined deployment plan. A content and determination mode of the candidate deployment plan may be similar to that of the deployment plan, as described in FIG. 2 and the related descriptions.

In some embodiments, the smart gas safety management platform may construct the plurality of candidate deployment graphs 440 based on the gas pipeline network 420, the at least one emergency processing point 430, and the plurality of candidate deployment plans 410.

For more detailed contents of the gas pipeline network and the emergency processing point, please refer to FIG. 2 and the related descriptions.

The candidate deployment graph 440 may be a data structure consisting of nodes and edges, the edges connecting the nodes, and the nodes and the edges may have features.

In some embodiments, the nodes of the candidate deployment graph 440 may correspond to the emergency processing point, and the edges of the candidate deployment graph 440 may correspond to connectivity relationships between the point locations.

A node feature may reflect a relevant feature of the emergency processing point.

In some embodiments, when the emergency processing point includes a point to be supplied with gas and a point to be repaired, a node of the candidate deployment graph 440 may include an emergency gas supply point and an emergency maintenance point. The node feature of the emergency gas supply point may include a crossover parameter and a gas supply parameter. The node feature of the emergency maintenance point may include a pipeline failure feature. For more information about the crossover parameter and the gas supply parameter, please refer to FIG. 2 and the associated descriptions.

The pipeline failure feature refer to a failure situation of the pipeline. For example, the pipeline failure feature may include a failure type, a failure time, etc. In some embodiments, the smart gas safety management platform may obtain the pipeline failure feature from the smart gas object platform using the smart gas sensor network platform.

In some embodiments, the node of the candidate deployment graph 440 may also include an emergency reinforcement point when the emergency processing point also includes a point to be reinforced. The node feature of the emergency reinforcement point may include a reinforcement parameter. The reinforcement parameter may be associated with the gas emergency vehicle performing a pipeline reinforcement. For example, the reinforcement parameter may include a pipeline material, a supporting structure, etc.

In some embodiments, the node of the candidate deployment graph 440 may also include a non-emergency processing point. The non-emergency processing point refer to the pipeline in the gas pipeline network other than the emergency processing point.

The node feature of the non-emergency processing point may include a gas pipeline feature and a gas transportation feature. For further details on the gas pipeline feature, please refer to FIG. 3 and the related descriptions.

The gas transportation feature refers to a feature associated with a gas transportation process. For example, the gas transportation feature may include a gas flow rate, a gas pressure, a gas temperature, and similar features in the pipeline.

In some embodiments, the smart gas safety management platform may obtain the gas pipeline feature and the gas transportation feature from the smart gas object platform through the smart gas sensor network platform.

In some embodiments, the node features of the emergency gas supply point, the emergency maintenance point, and the emergency reinforcement point of the candidate deployment graph 440 may also include the gas pipeline feature and the gas transportation feature.

In some embodiments of the present disclosure, the nodes of the candidate deployment graph may include the emergency gas supply point, the emergency maintenance point, the emergency reinforcement point, and the non-emergency processing point. In this way, the data structure may be more realistic, thereby better describing the connections between different entities, and facilitating subsequent processing.

In some embodiments, the edges of the candidate deployment graph 440 may correspond to the connectivity relationships between point locations. That is, the edge may be constructed between two point locations where there is a connectivity relationship. The connectivity relationship refers to an interconnection of two pipelines.

In some embodiments, the smart gas safety management platform may determine the failure probability of each node in the candidate deployment graph 440 at least one future moment based on the failure prediction model 450. In some embodiments, the failure prediction model 450 may be a GNN model. An input of the failure prediction model 450 may be the candidate deployment graph 440, and an output may be the failure probability of each node in the candidate deployment graph 440 at least one future moment, where the output of the GNN corresponds to the failure probability of the node.

The failure prediction model 450 may also be other graph models (e.g., a GCNN) or a graph neural network model with additional processing layers and modified processing modes.

In some embodiments, the failure prediction model 450 may be obtained by training a third training sample with a third label. For example, the third training sample may be a historical candidate deployment graph determined based on historical data. The node, the feature, and the edge of the historical candidate deployment graph may be similar to the above descriptions. The third label may be an actual failure at least one moment in a period of time after an obtaining of the third training sample (e.g., 1 for failure occurrence and 0 for no failure).

The failure probability of each node in the candidate deployment graph 440 at least one future moment may constitute the failure probability set 460.

The estimated impact degree set 470 refers to a set of estimated impact degrees corresponding to each node in the candidate deployment graph.

The estimated impact degree refers to an extent of impact on a residential gas usage after a failure of the gas pipeline corresponding to the node. The greater the estimated impact degree, the greater the impact on residential gas usage caused by the failure.

In some implementations, the estimated impact degree may be determined based on the historical data. For example, the smart gas safety management platform may determine the estimated impact degree of a specific pipeline based on the impact degree of the pipeline when the pipeline fails in the historical data.

In some implementations, the estimated impact degree may be determined based on a predetermined table. The predetermined table may include different gas pipelines and their corresponding reference impact degrees. The reference impact degree may be determined based on prior knowledge or the historical data.

In some embodiments, the estimated impact degree may correlate to the node type of the candidate deployment graph. For example, the estimated impact degrees corresponding to different node types may be predetermined based on the prior knowledge or the historical data. For another example, when a node changes from a non-emergency processing point to the emergency processing point, the estimated impact degree after the change may be determined by multiplying the estimated impact degree corresponding to the non-emergency processing point by a predetermined factor.

In some embodiments of the present disclosure, the estimated impact degree, which is related to the node type of the candidate deployment graph, enables a more accurate assessment of the actual impact of the candidate deployment graph, so as to determine a target deployment graph.

In some embodiments, the smart gas safety management platform may determine corresponding sub-scores based on the failure probability set 460 and the estimated impact degree set 470, respectively. Then, a weighted summation of the two sub-scores may be performed. The candidate deployment graph with the lowest summation result may be determined as the target deployment graph 480.

In some embodiments, the sub-score corresponding to the failure probability set 460 (also referred to as the first sub-score) may be determined based on a number of the failure probabilities in the failure probability set that are greater than a probability threshold (also referred to as the first number). The smaller the first number, the lower the first sub-score.

In some embodiments, the sub-score corresponding to the estimated impact degree set 470 (also referred to as the second sub-score) may be determined based on a number of estimated impact degrees in the estimated impact degree set that are less than the impact threshold (also referred to as the second number). The higher the second number, the lower the second sub-score.

In some embodiments, the smart gas safety management platform may determine a score for each of the plurality of the candidate deployment graphs 410 based on the failure probability set 460 and the estimated impact degree set 470 of the plurality of the candidate deployment graphs 410. Then, based on the score of each of the plurality of the candidate deployment graphs 410, the target deployment graph 480 may be determined.

In some embodiments, the score may be obtained using formula (1):

A=Σᵢ₌₁ⁿxᵢ×yᵢ (1)

where A denotes the score, n denotes the number of nodes, denotes the probability of failure for node i, and denotes the predicted impact of node i.

In some embodiments, the smart gas safety management platform may select the candidate deployment graph 410 with the smallest score to be determined as the target deployment graph 480.

In some embodiments of the present disclosure, by combining the failure probability set and the estimated impact degree set to determine the target deployment graph, an actual impact of each candidate deployment graph may be more accurately assessed, which helps to make a wiser decision and ensure that the selected target deployment graph satisfies the requirements.

In some embodiments, the smart gas safety management platform may determine the candidate deployment plan corresponding to the target deployment graph 480 as the final deployment plan 490.

In some embodiments of the present disclosure, the target deployment graph may be determined by integrating the failure probability set and the estimated impact of a plurality of candidate deployment plans, and the deployment plan for the gas emergency vehicle may be determined based on the target deployment graph. In this way, a decision-making accuracy may be improved, a system performance may be optimized, a reliability may be improved, and a maintenance cost may be reduced.

Some embodiments of the present disclosure provide a non-transitory computer-readable storage medium storing computer command. When reading the computer command in the storage medium, a computer implements the method for assessing a smart gas emergency plan of any embodiment of the present disclosure.

The basic concepts have been described above and it is apparent to those skilled in the art that the foregoing detailed disclosure serves only as an example and does not constitute a limitation of the present disclosure. Although not expressly stated herein, various modifications, improvements, and amendments may be made to the present disclosure by those skilled in the art. Those types of modifications, improvements, and amendments are suggested in the present disclosure, and therefore remain within the spirit and scope of the exemplary embodiments of the present disclosure.

Additionally, the present disclosure uses specific words to describe embodiments of the disclosure. For example, “an embodiment”, “one embodiment”, and/or “some embodiments” mean a feature, structure, or characteristic associated with at least one embodiment of the present disclosure. Accordingly, it should be emphasized and noted that when “one embodiment” or “an embodiment” is referred to two or more times in different locations in the present disclosure, they do not necessarily refer to the same embodiment. In addition, certain features, structures, or features in one or more embodiments of the present disclosure may be suitably combined.

Additionally, unless expressly stated in the claims, the order of processing elements and sequences, the use of numerical letters, or the use of other names described herein are not intended to limit the order of the processes and methods of the present disclosure. While some embodiments of the disclosed inventions are discussed by way of various examples in the foregoing disclosure, it should be understood that such details serve only illustrative purposes. The additional claims are not limited to the disclosed embodiments. Instead, the claims are intended to cover all amendments and equivalent combinations that are consistent with the substance and scope of the embodiments described in the present disclosure. For example, although the above-described system components may be implemented through hardware devices, they may also be implemented solely through software solutions, such as by installing the system described on existing servers or mobile devices.

Similarly, it should be noted that, for the purpose of simplifying the description in this disclosure and aiding in the understanding of one or more embodiments of the invention, the foregoing description of embodiments sometimes groups the plurality of features together in a single embodiment, figure, or description thereof. However, this method of disclosure does not imply that the objects of the present disclosure require more features than those mentioned in the claims. Rather, the claimed subject matter may lie in less than all features of a single disclosed embodiment.

Numbers describing the number of components, attributes, and properties are used in some embodiments, and it should be understood that such numbers used in the description of embodiments are modified in some examples by the modifiers “approximately”, “nearly”, or “substantially”. In some examples, the modifiers “approximately”, “nearly”, or “generally” are used. Unless otherwise noted, the terms “about,” “approximate,” or “roughly” indicate that a ±20% variation in the stated number is allowed. Correspondingly, in some embodiments, the numerical parameters used in the disclosure and claims are approximations, and these approximations may vary depending on the desired features of individual embodiments. In some embodiments, the numerical parameters should consider the specified number of valid digits and employ general place-keeping. While the numerical domains and parameters used to confirm the breadth of their ranges in some embodiments of the present disclosure are approximations, in specific embodiments such values are set to be as precise as possible within the feasible range.

For each patent, patent application, patent application disclosure, and other material cited in this disclosure, such as articles, books, disclosure sheets, publications, documents, etc., the entire contents of which are hereby incorporated herein by reference. Except for application history documents that are inconsistent with or create a conflict with the contents of this disclosure, and except for documents that limit the broadest scope of the claims of this disclosure (currently or hereafter appended to this disclosure). It should be noted that in the event of any inconsistency or conflict between the descriptions, definitions, and/or use of terminology in the materials appended to this disclosure and those set forth in this disclosure, the descriptions, definitions and/or use of terminology in the present disclosure shall prevail.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A method for assessing a smart gas emergency plan, comprising:
obtaining a warning information distribution of a gas pipeline network, the warning information distribution including warning information of at least one warning point location, the warning point location being a pipeline currently sending an alarm;
obtaining gas monitoring data of at least one associated point location corresponding to the at least one warning point location, the at least one associated point location being adjacent to the warning point location;
determining, based on the warning information distribution and the gas monitoring data of the at least one associated point location, at least one emergency processing point; and
determining, based on a gas supply blockage range of the at least one emergency processing point, a deployment plan for a gas emergency vehicle.

2. The method of claim 1, wherein the associated point location is determined in a manner comprising:
determining, based on a point feature of the warning point location and historical anomaly data, a synchronized anomaly point location, the synchronized anomaly point location having a plurality of synchronized anomalies with the warning point location; and
determining, based on the synchronized anomaly point location, the at least one associated point location.

3. The method of claim 2, wherein the determining, based on a point feature of the warning point location and historical anomaly data, a synchronized anomaly point location comprises:
determining, based on the point feature of the warning point location and the historical anomaly data, an anomaly point location set, the anomaly point location set including a plurality of anomaly point locations with an anomaly degree greater than an anomaly degree threshold, the anomaly point location being a pipeline experiencing anomaly; and
determining, based on the anomaly point location set, the synchronized anomaly point location.

4. The method of claim 3, wherein different anomaly point location sets correspond to different anomaly degree thresholds, the anomaly degree threshold being at least related to a total number of anomalies in the anomaly point location set and a distance distribution of the anomalies in the anomaly point location set.

5. The method of claim 4, wherein the anomaly degree threshold is further related to a service life of a gas pipeline network.

6. The method of claim 1, wherein the emergency processing point further includes points to be reinforced, the determining, based on the warning information distribution and the gas monitoring data of the at least one associated point location, at least one emergency processing point comprising:
determining the points to be reinforced based on the warning information distribution and the gas monitoring data of the at least one associated point location by a point location prediction model, the point location prediction model being a machine learning model.

7. The method of claim 6, wherein the point location prediction model is a graph neural network model, an input of the point location prediction model including a pipeline network graph constructed based on a gas pipeline network structure, and an output of the point location prediction model including the point to be reinforced; nodes of the pipeline network graph corresponding to pipelines, and a node feature of the pipeline network graph at least including the warning information, the gas monitoring data; an edge of the pipeline network graph corresponding to an adjacency between the pipelines, and an edge feature of the pipeline network graph at least including a gas flow direction.

8. The method of claim 7, wherein the node feature of the pipeline network graph further includes a gas pipeline feature, a geographic location, and an environmental feature.

9. The method of claim 1, wherein the determining, based on a gas supply blockage range of the at least one emergency processing point, a deployment plan for a gas emergency vehicle comprises:
determining a plurality of candidate deployment plans;
constructing, based on the gas pipeline network, the at least one emergency processing point, and the plurality of candidate deployment plans, a plurality of candidate deployment graphs; nodes of each of the candidate deployment graphs corresponding to the emergency processing points, and an edge of each of the candidate deployment graphs corresponding to a connection relationship between the emergency processing points;
for each candidate deployment graph, determining, based on a failure prediction model, a failure probability of each node in the candidate deployment graph at at least one future moment;
determining, based on a failure probability set and an estimated impact degree set for each of the plurality of the candidate deployment graphs, a target deployment graph; and
determining, based on the target deployment graph, the deployment plan for the gas emergency vehicle.

10. The method of claim 9, wherein the determining, based on a failure probability set and an estimated impact degree set for each of the plurality of the candidate deployment graphs, a target deployment graph comprises:
determining, based on the failure probability set and the estimated impact degree set for each of the plurality of the candidate deployment graphs, a score for each of the plurality of candidate deployment graphs; and
determining, based on the score of each of the plurality of candidate deployment graphs, the target deployment graph.

11. The method of claim 9, wherein the estimated impact degree is related to a node type of the candidate deployment graph.

12. An Internet of Things (IoT) system for assessing a smart gas emergency plan including a smart gas user platform, a smart gas service platform, a smart gas safety management platform, a smart gas sensor network platform, and a smart gas object platform, wherein the smart gas safety management platform is configured to:
obtain an warning information distribution of a gas pipeline network, the warning information distribution including warning information of at least one warning point location, the warning point location being a pipeline currently sending an alarm;
obtain gas monitoring data of at least one associated point location corresponding to the at least one warning point location, the at least one associated point location being adjacent to the warning point location;
determine, based on the warning information distribution and the gas monitoring data of the at least one associated point location, at least one emergency processing point; and
determine, based on a gas supply blockage range of the at least one emergency processing point, a deployment plan for a gas emergency vehicle.

13. The IoT system of claim 12, wherein the smart gas safety management platform is configured to:
determine, based on a point feature of the warning point location and historical anomaly data, a synchronized anomaly point location, the synchronized anomaly point location having a plurality of synchronized anomalies with the warning point location; and
determine, based on the synchronized anomaly point location, the at least one associated point location.

14. The IoT system of claim 13, wherein the smart gas safety management platform is configured to:
determine, based on the point feature of the warning point location and the historical anomaly data, an anomaly point location set, the anomaly point location set including a plurality of anomaly point locations with an anomaly degree greater than an anomaly degree threshold, the anomaly point location being a pipeline experiencing anomaly; and
determine, based on the anomaly point location set, the synchronized anomaly point location.

15. The IoT system of claim 14, wherein different anomaly point location sets correspond to different anomaly degree thresholds, the anomaly degree thresholds being at least related to a total number of anomalies in the anomaly point location set and a distance distribution of the anomalies in the anomaly point location set.

16. The IoT system of claim 12, wherein the emergency processing point further includes points to be reinforced, the smart gas safety management platform is configured to:
determine the points to be reinforced based on the warning information distribution and the gas monitoring data of the at least one associated point location by a point location prediction model, the point location prediction model being a machine learning model.

17. The IoT system of claim 16, wherein the point location prediction model is a graph neural network model, an input of the point location prediction model including a pipeline network graph constructed based on a gas pipeline network structure, and an output of the point location prediction model including the point to be reinforced; nodes of the pipeline network graph corresponding to pipelines, and a node feature of the pipeline network graph at least including the warning information, the gas monitoring data; an edge of the pipeline network graph corresponding to an adjacency between the pipelines, and an edge feature of the pipeline network graph at least including a gas flow direction.

18. The IoT system of claim 17, wherein the node feature of the pipeline network graph further includes a gas pipeline feature, a geographic location, and an environmental feature.

19. The IoT system of claim 12, wherein the smart gas safety management platform is configured to:
determine a plurality of candidate deployment plans;
construct, based on the gas pipeline network, the at least one emergency processing point, and the plurality of candidate deployment plans, a plurality of candidate deployment graphs; nodes of each of the candidate deployment graphs corresponding to the emergency processing points, and an edge of each of the candidate deployment graphs corresponding to a connection relationship between the point locations;
for each candidate deployment graph, determine, based on a failure prediction model, a failure probability of each node in the candidate deployment graph at at least one future moment;
determine, based on a failure probability set and an estimated impact degree set for each of the plurality of the candidate deployment graphs, a target deployment graph; and
determine, based on the target deployment graph, the deployment plan for the gas emergency vehicle.

20. A non-transitory computer-readable storage medium storing computer instructions, wherein when reading the computer instructions in the storage medium, a computer implements the method for assessing a smart gas emergency plan of claim 1.
